(19) United States
(12) Patent Application Publication
(10) Pub. No.: US 2004/0167018 A1
(43) Pub. Date: Aug. 26, 2004

(54) Palladium catalysts

(76) Inventors: Paul Adriaan Van Der Schaaf, Allschwil (CH); Roman Kolly, Allschwil (CH); Michael Tinkl, Eiken (CH)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/486,135

(22) PCT Filed: Aug. 1, 2002
(86) PCT No.: PCT/EP02/08589

(30) Foreign Application Priority Data
Aug. 10, 2001 (EP) 01810769.8

(51) Int. Cl. C07F 15/00; B01J 31/00

(52) U.S. Cl. 502/162; 546/2

(57) ABSTRACT

The invention relates to catalysts allowing for C—C or C—N coupling, their manufacture and use, said catalysts having the formula I wherein (I) R₁ and R₂ with R₃ and R₄ and R₅ and R₆, and the binding atoms are quinolylene; (ii) R₃ and R₄ with R₅ and R₆ and R₇ and R₈, and the binding atoms are naphtylene; (iii) R₃ and R₄ with R₅ and R₆ and R₇ and R₈, and the binding atoms are phenylene, (iv) R₅ and R₆, with R₇ and R₈, and the binding atoms are phenylene; or (v) R₁ and R₂, with R₃ and R₄, and the binding atoms are pyridylene, while R₅ and R₆, with R₇ and R₈, and the binding atoms are phenylene; where the rings may in each case be unsubstituted or substituted; the remaining radicals of R₁ to R₈ are hydrogen or an organic group; dotted lines in formula I represent absent or present bonds; X is an anionic ligand; and L is a tertiary phosphine moiety.

### SUMMARY OF THE INVENTION

The invention relates to novel palladium catalysts comprising a bidentate monoanionic phenylamine or benzylamine type ligand, processes for the manufacture thereof, and their use as catalysts in organic synthesis, especially for C—C and C—N coupling reactions; as well as novel intermediates.

### BACKGROUND OF THE INVENTION

Frequently used methods for C—C couplings of aromatics are, for example, the palladium-catalysed cross-coupling (so-called Suzuki coupling) in which iodine or bromine aromatic compounds or arylsulfonates are reacted with alkylboron derivatives in the presence of palladium catalysts (see, e.g., N. Miayura et al., Synthetic Communications 11, 513 (1981); A. Suzuki in: Metal-catalyzed Cross-coupling Reactions, chapter 2, Wiley-VCH, Weinheim 1998; U.S. Pat. No. 5,130,439; or EP 0 470 795). In order to obtain aromatic olefins, the palladium-catalyzed Heck reaction, is used for coupling, in which iodine or bromine aromatic compounds are reacted with olefins in the presence of palladium catalysts (see, e.g., R. F. Heck, Acc. Chem. Res. 12,146 (1979); R. F. Heck, Org. Reactions 27, 345 (1982); R. F. Heck, Palladium Reactions in Synthesis, Academic Press, London 1985; or S. Bräse and A. De Meijere in: Metal-catalyzed Cross-coupling Reactions, chapter 3, Wiley-VCH, Weinheim 1998).

Examples for C—N coupling reactions are, inter alia, provided in (a) M. Nishiyama et al., Tetrahedron Lett. 39, 617-20 (1998) and (b) T. Yamamoto et al., Tetrahedron Lett. 39, 236770 (1998) and references cited in (a) and/or (b). Examples are the synthesis of N-aryl- and N-heteroarylpiperazines from aryl halides and unprotected piperazine (see e.g. (a)) and the synthesis of triarylamines from diarylamines and aryl halides or from aryl di- or polyhalides with diarylamines (see e.g. (b)).

Among the drawbacks of these reactions are that, if the catalysts is not used in amounts in excess of 1 mol %, only small amounts can be produced, thus leading only to production on small laboratory scale. In addition, the use of conventional palladium catalysts, such as Pd(PPh₃)₄ (Ph=phenyl), Pd(OAc)₂ (Ac=acetate) and triphenyl phosphine, leads to undesirable side reactions through aryl transfer from the catalyst to the substrate (see D. F. O'Keefe er al., Tetrahedron Lett. 1992, 6679). Recovery of the palladium catalyst from the reaction mixture after the desired coupling is a tedious task, first requiring conversion of the palladium catalyst into a simple palladium salt, e.g. palladium chloride or palladium acetate.

With this background, it is an object of the present invention to provide a novel class of palladium catalysts for C—C or C—N coupling reactions which allow for an improved turnover number (mol product/mol catalyst), enhanced reactivity and selectivity over catalysts used hitherto in such coupling reactions, reactivity in very low concentrations and/or fine tuning for specific reactions by allowing for the use of specific complexes with specific electronic or steric properties.

### GENERAL DESCRIPTION OF THE INVENTION

One or more of the objects mentioned above are achieved by the novel palladium catalysts comprising a bidentate monoanionic phenylamine or benzylamine type amine ligand as described in more detail below. Especially, the catalysts of formula I presented below allow for very high product yield and/or high activity even in very low amounts. The catalysts can be prepared very easily. The phenylamine or benzylamine type ligands, due to their variability in substitution patterns, allow a high degree of fine-tuning to find optimal catalysts for specific synthetic transformation reactions.

The catalysts according to the invention therefore are of high value in organic synthesis, not only in laboratory, but also pilot or industrial scale.

### DETAILED DESCRIPTION OF THE INVENTION

The invention relates to catalysts of the formula I,

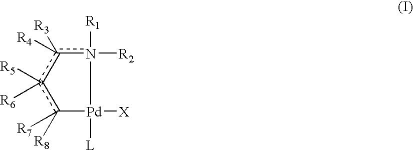

wherein

either

(i) R₁ and R₂ together with R₃ and R₄ and R₅ and Re, and together with the atoms to which they are bound, form an unsubstituted or substituted quinolylene ring system, while R₇ and R₈, independently of each other, are hydrogen or an organic group; or

(ii) R₃ and R₄ together with R₅ and R₆ and R₇ and R₈, and together with the atoms to which they are bound, form an unsubstituted or substituted naphthylene ring system, while R₁ and R₂, independently of each other, are H or an organic group; or

(iii) R₃ and R₄ together with R₅ and R₆, and together with the atoms to which they are bound, form an unsubstituted or substituted phenylene ring, while R₁, R₂, R₇ and R₈, independently of each other, are H or an organic group; or

(iv) R₅ and R₆, together with R₇ and R₈, and together with the atoms to which they are bound, form an unsubstituted or substituted phenylene ring, while R₁, R₂, R₃ and R₄, independently of each other, are H or an organic group; or

(v) R₁ and R₂, together with R₃ and R₄, and together with the atoms to which they are bound form an unsubstituted or substituted pyridylene ring, while R₅ and R₆, together with R₇ and R₈, and together with the atoms to which they are bound, form an unsubstituted or substituted phenylene ring;

with the proviso that where R₁ and R₂ do not form part of an unsubstituted or substituted quinolylene or pyridylene ring system they may, instead of each being hydrogen or an organic group, together form an unsubstituted or substituted alkylene that together with the binding nitrogen forms a ring;

where the bonds represented by dotted lines in formula I together with the adjacent bonds in solid line in the case that they are part of a phenyl or pyridyl ring are delocated double bonds forming part of the phenyl or pyridyl ring, in case that they are not part of such a ring are absent;

X is an anionic ligand;

and L is a tertiary phosphine moiety.

The invention also relates to a process for the manufacture of said complexes, as well as their use and to novel intermediates.

Unless otherwise indicated, the general terms and names used in the description of the present invention preferably have the following meanings (where more specific definitions, in each case separately, or in combination, may be used to replace more general terms in order to define more preferred embodiments of the invention):

The term ‘lower’ defines a moiety with up to and including maximally 7, especially up to and including maximally 4, carbon atoms, said moiety being branched or straight-chained. Lower alkyl, for example, is methyl, ethyl, n-propyl, sec-propyl, n-butyl, isobutyl, sec-butyl, tert-butyl, n-pentyl, n-hexyl or n-heptyl.

“Substituted”, whereever used for a moiety, means that one or more hydrogen atoms in the respective molecule, especially up to 5, more especially up to three, of the hydrogen atoms are replaced by the coreresponding number of substituents which preferably are independently selected from the group consisting of lower alkyl, for example methyl, ethyl or propyl, halo-lower alkyl, for example trifluoromethyl, C₆-C₁₆-aryl, especially phenyl or naphthyl (where C₆-C₁₆-aryl, especially phenyl or napthyl, is unsubstituted or substituted by one or more, especially up to three moieties selected from halogen, carboxy, lower alkoxycarbonyl, hydroxy, lower alkoxy, phenyl-lower alkoxy, lower alkanoyloxy, lower alkanoyl, amino, N-lower alkylamino, N,N-di-lower alkylamino, N-phenyl-lower alkylamino, N,N-bis(phenyl-lower alkyl)-amino, lower alkanoylamino, halo-lower alkyl, e.g. trifluoromethyl, sulfo, cyano and nitro), hydroxy, lower alkoxy, for example methoxy, phenyl-lower alkoxy, lower alkanoyloxy, amino, N-lower alkylamino, N,N-di-lower alkylamino, N-phenyl-lower alkylamino, N,N-bis-(phenyl-lower alkyl)-amino, lower alkanoylamino, carbamoyl-lower alkoxy, N-lower alkylcarbamoyl-lower alkoxy or N,N-di-lower alkylcarbamoyl-lower alkoxy, amino, mono- or di-lower alkylamino, lower alkanoylamino, halogen, for example fluorine, chlorine or bromine, carboxy, lower alkoxycarbonyl, phenyl-, naphthyl- or fluorenyl-lower alkoxycarbonyl, such as benzyloxycarbonyl, lower alkanoyl, sulfo, lower alkanesulfonyl, for example methanesulfonyl (CH₃—S(O)₂—), phosphono (—P(═O)(OH)₂), hydroxy-lower alkoxy phosphoryl or di-lower alkoxyphosphoryl, carbamoyl, mono- or di-lower alkylcarbamoyl, sulfamoyl, mono- or di-lower alkylaminosulfonyl, nitro and cyano.

Halo or Halogen is preferably fluoro, chloro, bromo or iodo, most preferably fluoro, chloro or bromo.

An unsubstituted or substituted quinolylene ring system formed from R₁, R₂, R₃, R₄, R₅ and R₆ together with the binding atoms in formula I is a quinoline-1,8-ene ring system and is subsituted by one or more, especially up to three, substitutents, preferably substitutents selected from the group defined above. Preferred is an unsubstituted quinoline ring system.

An unsubstituted or substituted pyridylene ring formed from R₁, R₂, R₃ and R₄, together with the bindng atoms, is a pyridin-1,2-ylene ring system and is substituted by one of more, especially up to three, substitutents, preferably substituents selected from the group defined above. Preferred is an unsubstituted pyridylene.

An organic group is preferably alkyl, cycloalkyl, aryl or heterocyclyl, each of which is unsubstituted (preferred) or substituted by one or more, especially up to three, substitutents independently selected from those defined as defined above under “Substituted”.

Alkyl preferably has up to 12 carbon atoms and is linear or branched one or more times; preferred is lower alkyl, especially C₁-C₄-Alkyl. Unsubstituted alkyl, prefeably lower alkyl, is especially preferred as an “organic group”.

Cycloalkyl preferably has 3 to 12, especially 3 to 8 carbon atoms, for example in cyclopropyl, cyclobutyl, cyclopentyl or cyclohexyl. Unsubstituted C₃-C₈-cycloalkyl, preferably cyclohexyl, is especially preferred as organic moiety.

Aryl preferably has a ring system of not more than 20 carbon atoms, especially not more than 16 carbon atoms, is preferably mono-, bi- or tric-cyclic, and is unsubstituted or substituted preferably as defined above; for exampe, aryl is selected from phenyl, naphthyl, indenyl, azulenyl and anthryl, and is preferably in each case unsubstituted or substituted phenyl or (especially 1- or 2-) naphthyl. Unsubstituted aryl is preferred. Unsubstituted aryl, preferably phenyl, is especially preferred as organic moiety.

Heterocyclyl is preferably a heterocyclic radical that is unsaturated, saturated or partially saturated in the bonding ring and is preferably a monocyclic or in a broader aspect of the invention bicyclic or tricyclic ring; has 3 to 24, more preferably 4 to 16 ring atoms; wherein at least in the ring bonding to the radical of the molecule of formula I one or more, preferably one to four, especially one or two carbon ring atoms are replaced by a heteroatom selected from the group consisting of nitrogen, oxygen and sulfur, the bonding ring preferably having 4 to 12, especially 5 to 7 ring atoms; heteroaryl being unsubstituted or substituted by one or more, especially 1 to 3, substitutents independently selected from the group consisting of the substituents defined above; especially being a heteroaryl radical selected from the group consisting of oxiranyl, azirinyl, 1,2-oxathiolanyl, imidazolyl, thienyl, furyl, tetrahydrofuryl, pyranyl, thiopyranyl, thianthrenyl, isobenzofuranyl, benzofuranyl, chromenyl, 2H-pyrrolyl, pyrrolyl, pyrrolinyl, pyrrolidinyl, imidazolyl, imidazolidinyl, benzimidazolyl, pyrazolyl, pyrazinyl, pyrazolidinyl, pyranyol, thiazolyl, isothiazolyl, dithiazolyl, oxazolyl, isoxazolyl, pyridyl, pyrazinyl, pyrimidinyl, piperidyl, piperazinyl, pyridazinyl, morpholinyl, thiomorpholinyl, indolizinyl, isoindolyl, 3Hindolyl, indolyl, benzimidazolyl, cumaryl, indazolyl, triazolyl, tetrazolyl, purinyl, 4H-quinolizinyl, isoquinolyl, quinolyl, tetrahydroquinolyl, tetrahydroisoquinolyl, decahydroquinolyl, octahydroisoquinolyl, benzofuranyl, dibenzofuranyl, benzothiophenyl, dibenzothiophenyl, phthalazinyl, naphthyridinyl, quinoxalyl, quinazolinyl, quinazolinyl, cinnolinyl, pteridinyl, carbazolyl, β-carbolinyl, phenanthridinyl, acridinyl, perimidinyl, phenanthrolinyl, furazanyl, phenazinyl, phenothiazinyl, phenoxazinyl, chromenyl, isochromanyl and chromanyl, each of these radicals being unsubstituted or substituted by one to two radicals selected from the group consisting of lower alkyl, especially methyl or tert-butyl, lower alkoxy, especially methoxy, and halo, especially bromo or chloro. Unsubstituted heterocyclyl is preferred.

Where R₁ and R₂ do not form part of an unsubstituted or substituted quinolylene or pyridylene ring system so that they may together form an unsubstituted or substituted alkylene that together with the binding nitrogen forms a ring (instead of hydrogen or organic groups R₁ and R₂), said ring is preferably one formed with unsubstituted lower alkylene, especially C₃-C₆-alkylene, most preferably pentamethylene (thus, together with the binding nitrogen, forming a piperidine ring).

An unsubstituted or substituted naphthylene ring system is an naphthyl-1,8-ene ring that is unsubstituted or substituted as defined above. Unsubstituted naphthyl-1-8-ene is preferred.

An unsubstituted or substituted phenyl is an ortho-phenylene ring that is unsubstituted or substituted as defined above. Unsubstituted ortho-phenylene is preferred.

An anionic ligand is, for example, the hydride ion (H⁻), or preferably a ligand derived from anorganic or organic acids by removal If protons, for example halogenide ((F⁻, Cl⁻, Br⁻ or I⁻) or anions of oxo acids, or derivatves thereof, e.g. SnCl₃⁻, SnCl₅⁻, BF₄⁻, B(Aryl)₄⁻, PF₆⁻, SbF₆⁻ or AsF₆⁻.

Anions of oxo acids are, especially, sulfate, phosphate, perchlorate, perbromate, periodate, antimonate, arsenate, nitrate, carbonate, the anion of a (preferably C₁-C₈-) alkylcarbonic acid, e.g. formiate, acetate, propionate or butyrate, phenyl-lower alkyl- or phenyl-carbonic acids, e.g. benzoate, phenylacetate, mono-, di- or trichloro- or -fluoroacetate, organic sulfonates, for example mesylate, ethane sulfonate, propane sulfonat, n-butane sulfonate, trifluoromethansulfonate (triflate), unsubstftuted or C₁-C₄-alkyl-, C₁-C₄-alkoxy- or halo-, especially fluoro-, chloro- or bromo-substituted benzenesulfonate or p-toluenesulfonate, e.g. benzenesulfonate, tosylate, p-methoxy- or p-ethoxybenzenesulfonate, pentafluorobenzenesulfonate or 2,4,6-triisopropylbenzenesulfonate.

Especially preferred anionic ligands are H⁻, F⁻, Cr⁻, Br⁻, BF₄⁻, PF₆⁻, SnCl₃⁻, SbF₆⁻, AsF₆⁻, CF₃SO₃⁻, C₆H₅—SO₃⁻, 4-methyl-C₆H₅—SO₃⁻, 3,5-Dimethyl-C₆H₅—SO₃⁻, 2,4,6-Trimethyl-C₆H₅—SO₃⁻, 4-CF₃—C₆H₅—SO₃⁻, acetate or cyclopentadienyl (Cp⁻). Highly preferred are Cl⁻.

Br⁻ or I⁻ and most preferred is the anion of a lower alkylcarbonic acid, especially acetate.

A tertiary phosphine moiety preferably contains 3 to 40, more preferably 3 to 18, C-atoms. preferably it corresponds to the sub-formula IA

P(R₉)(R₁₀)(R₁₁) (IA),

wherein R₉, R₁₀ and R₁₁ are, independently of each other, are C₁-C₂₀-alkyl, C₃-C₁₂-cycloalkyl, C₂-C₁₁-heterocyclyl, C₆-C₁₆-aryl, C₇C₁₆-aralkyl or C₃-C₁₅-heterocyclylalkyl, where these moieties are unsubstituted or substituted by one or more, especially up to three, substituents independently selected from those mentioned above, especially from C₁-C₆-alkyl, C₁-C₆Alkoxy, C₁-C₆-Halogenalkyl, C₆-C₁₆-aryl, —NO₂, SO₃⁻, amino and halo. The moieties R₉ and R₁₀ together may further represent tetra- or pentamethylene that is unsubstituted or substituted by C₁-C₆-alkyl, C₁-C₆-halo-lower alkyl, —NO₂ or C₁-C₆-alkoxy, which in addition may be condensed with 1 or 2 bivalent 1,2-phenylene moieties, while R₁₁, has the meanings given above.

R₉, R₁₀ and R₁₁ as C₁-C₂₀-alkyl are, for example, lower alkyl, especially methyl, ethyl, n- or isopropyl or n-, sec- or tert-butyl as well as linear or branched pentyl, hexyl or heptyl; or further octyl, isooctyl, nonyl, tert-nonyl, decyl, undecyl or dodecyl.

R₉, R₁₀ and R₁₁ as unsubstituted or substituted C₃-C₁₂-cycloalkyl are, especially, C₃-C₈-cycloalkyl, especially cyclopropyl, dimethylcyclopropyl, cyclobutyl, cyclopentyl or cyclohexyl.

R₉, R₁₀ and R₁₁, as C₂-C₁₁-heterocyclyl preferably contain a corresponding heterocyclyl moiety as defined above, preferably with 4 to 5 ring C-atoms and one or two heteroatoms selected from the group consisting of O, S and N. Examples are the moieties derived from oxirane, azirine, 1,2-oxathiolane, pyrazoline, piperidine, piperazine, morpholine, tetrahydrofurane and tetrahydrothiophane.

R₉, R₁₀ and R₁₁ as C₆-C₁₆-Aryl are, for example, selected from those mentioned above under aryl and are especially C₆-C₁₄-aryl. They are preferably mono-, bi- or tricyclic, e.g. phenyl, naphthyl, indenyl, azulenyl or anthryl.

In arylalkyl, aryl and alkyl are unsubstituted (preferred) or substituted preferably as defined above. Preferably, aryl is mono-, bi- or tricyclic, e.g. phenyl, naphthyl, indenyl, azulenyl or anthryl, while alkyl is lower alkyl, especially methyl or ethyl The alkyl is preferably lower alkyl, especially C₁-C₄-alkyl, and preferably carries the aryl terminally, or in 1- or 2-position.

In C₃-C₁₅-heterocyclylalkyl, heterocyclyl and alkyl are unsubstituted (preferred) or substituted and preferably as defined above. Examples of heterocyclyl moieties are furyl, thiophenyl, pyrrolyl, pyridyl, γ-pyranyl, γ-thiopyranyl, phenanthrolinyl, pyrimidinyl, pyrazinyl, indol, cumaryl, thionaphthenyl, carbazolyl, dibenzofuranyl, dibenzothiophenyl, pyrazolyl, imidazolyl, benzimidazolyl, oxazolyl, thiazolyl, dithiazolyl, isoxazolyl, isothiazolyl, quinolyl, isoquinolyl, acridinyl, chromenyl, phenazinyl, phenoxazinyl, phenothiazinyl, triazinyl, thianthrenyl, purinyl or tetrazolyl. The alkyl is preferably lower alkyl, especially C₁-C₄-alkyl, and preferably carries the heterocyclyl terminally, or in 1- or 2-position.

C₇C₁₆-Aralkyl as R₉, R₁₀ und R₁₁ preferably has 7 to 12 C-atoms and is, for example, phenyl-lower alkyl, e.g. benzyl, 1- or 2-phenethyl or cinnamyl.

Very preferred as tertiary phosphine moiety is triphenylphosphino, tricyclohexylphosphino or tri-lower alkylphosphino, the latter being especially tri-isopropylphosphino.

Further sterically exacting moieties R₉, R₁₀ und R₁₁ are preferred, for example cyclic or branched, especially α,α-di-branched or very especially α-branched alkyl moieties, are preferred.

Especially preferred are those tertiary phosphine moieties of sub-formula 1A wherein R₉, R₁₀ and R₁₁ are methyl, ethyl, n- or iso-propyl, n-, iso-, sec- or tert-butyl, 1-, 2- or 3-pentyl, 1-, 2-, 3- or 4-hexyl, cyclopentyl, cyclohexyl, phenyl, naphthyl or benzyl, especially triphenylphosphinyl.

The complexes according to the invention are prepared by methods that, per se, are known in the art (though not with regard to the synthesis of the complexes of formula I), especially by reacting a compound of the formula II,

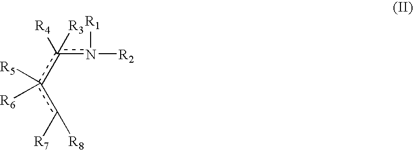

wherein R₁, R₂, R₃, R₄, R₅, R₆, R₇ and R₈ have the meanings given under formula I, with a palladium salt of the formula III,

Pd(X)₂ (III)

wherein X is an anionic ligand as described for compounds of the formula I, in an appropriate solvent, especially a halogenated, especially chlorinated, hydrocarbon, most especially a lower alkylhalogenide, such as chloroform or methylene chloride, preferably at temperatures between from 0 to 50° C., especially between from 20 to 30° C., isolating the product complex (usually, especially in case of lower alkylcarbonyl X, a lower alkylcarbonyl bridged dimer of compounds of formula II) and then, optionally directly in situ in the reagent mixture that is to be used for C—C— or C—N— coupling catalysis, reacting the product complex with the tertiary phosphine of the formula IV,

L (IV)

where L is a tertiary phosphine as defined for L for compounds of formula I, in an appropriate solvent, especially an ether, such as a cyclic ether, preferably tetrahydrofurane, at preferred temperatures between from 0 to 50° C., especially between from 20 to 30° C., and then either directly using the resulting complex of formula I or isolating it, e.g. by filtration, concentration under vacuum, redissolving and suspending in an apolar solvent, e.g. a hydrocarbon, expecially a lower alkane,such as hexane, and then isolating the undissolved material of the formula I, e.g. by filtration or centrifugation.

The starting materials, especially the compounds of the formula II, of the formula III and of the formula IV, respectively, are known, can be prepared according to methods known in the art or are commercially available.

In order to look for optimal catalysts with the appropriate substitution pattern, it is especially possible to use standard methods, e.g. reaction calorimetric assays as described in J. Le Bars et al., Adv. Synth. Catal. 343(2), 207-214 (2001), and references cited therein, e.g. regarding high throughput catalyst testing using thermal detection methods (see especially M. T. Reetz et al., Angew. Chem. Int. Ed. 37, 2647 (1998), M. T. Reetz et al., Angew. Chem. Int. Ed. 39,1236 (2000) and S. J. Taylor et al., Science 280, 267 (1998)).

The compounds of formula I can, for example, be used as catalysts in catalytic C—C— and C—N-coupling reactions.

For example, they can be used coupling of boronic acid derivatives of the formula V,

Y—B(OH)₂ (V)

wherein Y is aryl, preferably as defined above, e.g. phenyl, with an aryl halogenide of the formula VI,

Z-Hal (VI)

wherein Z is aryl, especially lower alkanoyl-phenyl, such as 4-acetyl-phenyl, or lower alkoxy-phenyl, such as 3-methoxyphenyl, and Hal is Halogen, especially bromo or iodo.

The reaction preferably takes place in the presence of a catalytic amount of a complex of the formula I, this preferably meaning an amout of 0.00001 to 15 mol-%, especially 0.0001 to 10 mol-% and most preferably 0.0005 to 5 mol-%, related to the amount of substrate to be reacted.

In addition, a base is present, preferably an inorganic base, especially an alkaline metal carbonate, such as potassium carbonate.

As solvent, especially hydrocarbons, preferably aromatic hydrocarbons, such as toluene or xylene, are used. The reaction preferably takes place at elevated temperatures, especially between 50° C. and reflux temperature, most preferably under reflux.

The reaction mixture is preferably degassed and the reaction led under an inert atmosphere, e.g. under nitrogen or argon.

The resulting product has the formula VII,

Y-Z (VII)

where Y and Z are as defined for compounds of the formula V and VI, respectively.

Alternatively, the compounds of the formula I can be used as catalysts (in catalytic amounts, preferably as defined above) in Heck-coupling reactions of olefins carbonic esters of the formula VIII

Q-R (VIII)

wherein Q is an α,β-unsaturated olefinic radical, e.g. α,β-unsaturated lower alkenyl, and R is an organic group, preferably as defined above, especially aryl, or an organic group bound via a carbonyl; preferably alkoxycarbonyl, especially lower alkoxycarbonyl, with a compound of the formula VI as defined above, the reaction preferably taking place in an appropriate solvent, preferably a polar aprotic solvent, e.g. a di-lower alkyl-lower alkylamide, such as di-methylformamide, in the presence of a base, especially the alkalimetal salt of a weak organic carbonic acid, such as sodium acetate, preferably under inert gas, such as nitrogen. The reaction is preferably led at elevated temperature, e.g. between 50° C. and reflux temperature, most preferably under reflux.

The resulting compound is one of the formula IX,

Z-C(Q*)=C—R, (IX)

where Z and R as defined for compounds of the formula VI and VIII, respectively, while Q* is hydrogen or the complementary part of an organic moiety Q as defined under formula VIII.

As further example for C—C-couplings, it is also possible to react a compound of the formula VI, as defined above, in the presence of catalytic amounts of a compound of the formula I, preferably as defined above, with carbon monoxide and an alcohol of the formula X,

Q**-OH (X)

wherein Q** has the meanings given for Q under formula VIII, especially lower alkyl, to provide the corresponding ester of the formula XI,

Z-C(═O)OQ** (XI)

wherein Z and Q** have the meanings just defined.

The reaction preferably takes palce in an autoclave in the alcohol of the formula X and in the presence of a tertiary nitrogen base, such as a tri-lower alkylamine, e.g. triethylamine, under inert gas and under an elevated carbon monoxide pressure, e.g. in the range from 2 to 40 bar, especially 15 to 25 bar, at elevated temperatures, especially in the range from 40 to 150° C., especially from 100 to 130° C.

### PREFERRED EMBODIMENTS OF THE INVENTION

In the following description of preferred embodiments of the invention, more general definitions can, each individually, by subgroups or preferably all together, be replaced with more specific definitions given above, thus leading to the definition of still more preferred embodiments of the invention.

The invention preferably relates to catalyst compounds of the formula I wherein

either

(i) R₁ and R₂ together with R₃ and R₄ and R₅ and R₆, and together with the atoms to which they are bound, form an unsubstituted or substituted quinolylene ring system, while R₇ and R₈, independently of each other, are hydrogen or an organic group; or

(ii) R₃ and R₄ together with R₅ and R₆ and R₇ and R₈, and together with the atoms to which they are bound, form an unsubstituted or substituted naphthylene ring system, while R₁ and R₂, independently of each other, are H or an organic group; or

(iii) R₃ and R₄ together with R₅ and R₆, and together with the atoms to which they are bound, form an unsubstituted or substituted phenylene ring, while R₁, R₂, R₇ and R₈, independently of each other, are H or an organic group; or

(iv) R₅ and R₆, together with R₇ and R₈, and together with the atoms to which they are bound, form an unsubstituted or substituted phenylene ring, while R₁, R₂, R₃ and R₄, independently of each other, are H or an organic group; or

(v) R₁ and R₂, together with R₃ and R₄, and together with the atoms to which they are bound form an unsubstituted or substituted pyridylene ring, while R₅ and R₆, together with R₇ and R₈, and together with the atoms to which they are bound, form an unsubstituted or substituted phenylene ring;

with the proviso that where R₁ and R₂ do not form part of an unsubstituted or substituted quinolylene or pyridylene ring system, R₃ and R₄ are, independently of each other, hydrogen or an organic group and R₅ and R₆, together with R₇ and R₈, and together with the atoms to which they are bound, form an unsubstituted or substituted phenylene ring, R₁ and R₂ may, instead of each being hydrogen or an organic group, together form an unsubstituted or substituted alkylene that together with the binding nitrogen forms a ring;

where the bonds represented by dotted lines in formula I together with the adjacent bonds in solid line in the case that they are part of a phenyl or pyridyl ring are delocated double bonds forming part of the phenyl or pyridyl ring, in case that they are not part of such a ring are absent;

X is an anionic ligand selected from the group consisting of halogen anions, especially Cl⁻, Br⁻ or I⁻, and most preferably the anion of a lower alkylcarbonic acid, especially acetate;

and L is a tertiary phosphine moiety.

More preferably, the invention relates to catalyst compounds of the formula I wherein

(i) R₁ and R₂ together with R₃ and R₄ and R₅ and R₆, and together with the atoms to which they are bound, form an unsubstituted quinolylene ring system, while R₇ and R₈, independently of each other, are hydrogen or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or

(ii) R₃ and R₄ together with R₅ and R₆ and R₇ and R₈, and together with the atoms to which they are bound, form an unsubstituted naphthylene ring system, while R₁ and R₂, independently of each other, are H or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or

(iii) R₃ and R₄ together with R₅ and R₆, and together with the atoms to which they are bound, form an unsubstituted phenylene ring, while R₁, R₂, R₇ and R₈, independently of each other, are H or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or

(iv) R₅ and R₆, together with R₇ and R₈, and together with the atoms to which they are bound, form an unsubstituted phenylene ring, while R₁, R₂, R₃ and R₄, independently of each other, are H or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or

(v) R₁ and R₂, together with R₃ and R₄, and together with the atoms to which they are bound form an unsubstituted pyridylene ring, while R₅ and R₆, together with R₇ and R₈, and together with the atoms to which they are bound, form an unsubstituted phenylene ring;

with the proviso that where R₁ and R₂ do not form part of an unsubsttuted quinolylene or pyriydylene ring system, R₃ and R₄ are, independently of each other, hydrogen or an organic group as defined and R₅ and 16, together with R₇ and R₈, and together with the atoms to which they are bound, form an unsubstituted phenylene ring, R₁ and R₂ may, instead of each being hydrogen or an organic group as defined, together form an unsubstituted or substituted C₃-C₆-alkylene that together with the binding nitrogen forms a ring;

X is an anionic ligand selected from the group consisting of halogen anions, especially Cl⁻, Br⁻ or I⁻, and most preferably the anion of a lower alkylcarbonic acid, especially acetate;

and L is a tertiary phosphine moiety of the formula IA

P(R₉)(R₁₀)(R₁₁) (IA),

wherein R₉, R₁₀ and R₁₁, are, independently of each other, lower alkyl, especially methyl, ethyl, n- or isopropyl or n-, sec- or tert-butyl as well as linear or branched pentyl, hexyl or heptyl; or further octyl, isooctyl, nonyl, tert-nonyl, decyl, undecyl or dodecyl; C₃-C₈-cycloalkyl, especially cyclopropyl, dimethylcyclopropyl, cyclobutyl, cyclopentyl or cyclohexyl; or C₆-C₁₄-aryl, especially phenyl, naphthyl, indenyl, azulenyl or anthryl.

Still more preferred are catalyst compounds of the formula I as defined above, especially according to the last two paragraphs, wherein R₁, R₂, R₃, R₄, R₅, R₆, R₇ and R₈ are as defined in any one of the groups (i), (ii), (iii), (iv) and (v), respectively, and the remaining symbols have the meanings given above, especially in said last two paragraphs, more preferably the last paragraph.

Very preferred are catalyst compound of the formula I wherein

(i) R₁ and R₂ together with R₃ and R₄ and R₅ and R₆, and together with the atoms to which they are bound, form an unsubstituted quinolylene ring system, while R₇ and R₈, independently of each other, are hydrogen, lower alkyl, C₃-C₈-cycloalkyl, especially cyclopentyl or cyclohexyl, or C₆-C₁₀-aryl, especially phenyl; or

(ii) R₃ and R₄ together with R₅ and R₆ and R₇ and R₈, and together with the atoms to which they are bound, form an unsubstituted naphthylene ring system, while R₁ and R₂, independently of each other, are H or are hydrogen, lower alkyl, C₃-C₈-cycloalkyl, especially cyclopentyl or cyclohexyl, or C₅-C₁₀-aryl, especially phenyl; or

(iii) R₃ and R₄ together with R₅ and R₆, and together with the atoms to which they are bound, form an unsubstituted phenylene ring, while R₁, R₂, R₇ and R₈, independently of each other, are H, are hydrogen, lower alkyl, C₃-C₈-cycloalkyl, especially cyclopentyl or cyclohexyl, or C₅-C₁₀-aryl, especially phenyl; or

(iv) R₅ and R₆, together with R₇ and R₈, and together with the atoms to which they are bound, form an unsubstituted phenylene ring, while R₁, R₂, R₃ and R₄, independently of each other, are hydrogen, lower alkyl, C₃-C₈-cycloalkyl, especially cyclopentyl or cyclohexyl, or C₆-C₁₀-aryl, especially phenyl; or

(v) R₁ and R₂, together with R₃ and R₄, and together with the atoms to which they are bound form an unsubstituted pyridylene ring, while R₅ and R₆, together with R₇ and R₈, and together with the atoms to which they are bound, form an unsubstituted phenylene ring;

with the proviso that where R₁ and R₂ do not form part of an unsubstituted quinolylene or pyridylene ring system, R₃ and R₄ are, independently of each other, hydrogen or an organic group selected from the group consisting of lower alkyl, C₃-C₈-cycloalkyl, especially cyclopentyl or cyclohexyl, and C₅-C₁₀-aryl, especially phenyl, and R₅ and R₆, together with R₇ and R₈, and together with the atoms to which they are bound, form an unsubstituted phenylene ring, R₁ and R₂ may, instead of each being hydrogen or an organic group as defined, together form an unsubstituted or substituted C₃-C₆-alkylene, especially pentamethylene, that together with the binding nitrogen forms a ring;

X is an anionic ligand selected from the group consisting of halogen anions, especially Cl⁻; Br⁻ or I⁻, and most preferably the anion of a lower alkylcarbonic acid, especially acetate;

and L is a tertiary phosphine moiety selected from triphenylphospinyl, tricyclohexylphosphinyl and tri-lower alkylphosphinyl, especially tri-isopropylphosphinyl.

Most preferably the invention relates to the catalysts of formula I, the manufacturing processes, the novel intermediates and/or the uses presented in the examples given below.

From the catalysts of the formula I, compounds I, II, III, IV, V, VII, VIII, IX, XI, XIV, XV, XVI, XVII, XIX or especially X and XII are most preferred.

### EXAMPLES

The following Examples are thought to illustrate the invention without limiting the scope thereof.

### Example 1

### Palladium Catalysts

The palladium catalyst precursors are prepared via a ortho-palladation reaction of commercially available palladium acetate with the corresponding ligand as described or in analogy to the method described by Ryabov et al in J. Chem. Soc., Perkin Trans. 1983, pp 1503-1508.

Experimental (representative):

Preparation of

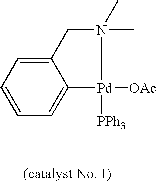

0.67 gram of N,N-dimethylbenzylamine are added slowly to a solution of 1 gram Pd(OAc)₂ in 30 ml chloroform. The reaction mixture is stirred for 2 hours and then filtered through silica. The resulting yellow solution is concentrated under vacuum, and the resulting oil is suspended in a few ml of hexane. The yellow suspension is centrifugated and the resulting yellow powder is dried in vacuum. This gives the intermediate of the symbolic formula

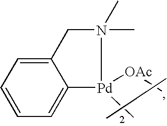

representing an acetate bridged dimer, in quantitative yields. This dimer is dissolved 10 ml THF, and 1 equivalent of triphenylphosphine are added. Then, the reaction mixture is stirred for 1 h. The resulting suspension is concentrated under vacuum, and the off-white powder is washed with hexane giving the desired product I in 90% yield as a yellowish powder. The ¹H and ³¹P NMR data are given in Table 1.

The corresponding analogues II to XIX are prepared in a similar way and obtained in high yields. The starting materials (ligands) are commercially available or can be prepared according to known procedures, as can be derived from the following table:

| Ligand | | |
|---|---|---|
| for | | |
| catalyst | | |
| number | Ligand structure | Origin |
| I, XVI, XVII | 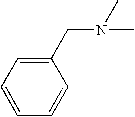 | Commercially available (Fluka, Buchs, Switzerland) |
| II | 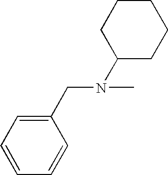 | 1 |
| III | 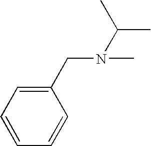 | 1 |
| IV | 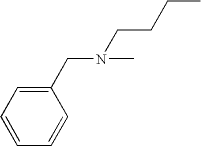 | 1 |
| V | 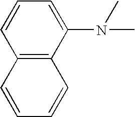 | Commercially available (Fluka) |
| VI | 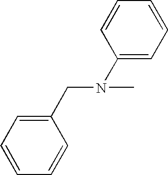 | Commercially available (Aldrich, Buchs, Switzerland) |
| VII | 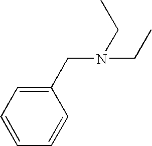 | 1 |
| VIII | 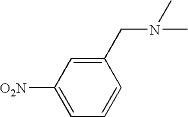 | 1 |
| IX | 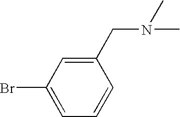 | 1 |
| X | 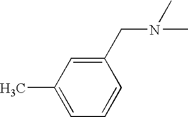 | 1 |
| XI | 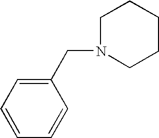 | 1 |
| XII | 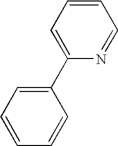 | Commercially available (Aldrich) |
| XIII | 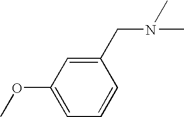 | Commercially available (Aldrich) |
| XIV | 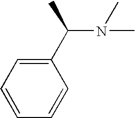 | Commercially available (Fluka) |
| XV | 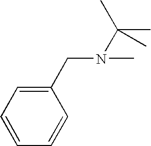 | 1 |
| XIX | 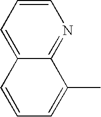 | Commercially available (Fluka) |

1: These known compounds are not commercially available and are prepared by reacting the corresponding, commercially available benzyl bromide with 2 equivalents of the secondary amine. After a normal work-up procedure the ligand is purified by destillation and obtained in good yields.

Generally, then the acetate bridged palladium compounds are reacted with the tertiary phosphine to obtain the final catalysts (this catalyst preparation can also be performed in situ).

The catalysts are then obtained, after evaporation of the solvent and washings with organic solvents, for example hexane or di-isopropyl ether, in good yields. The catalysts are characterized with ¹H and ³¹P NMR spectroscopy, see Table 1.

TABLE 1
¹H and ³¹P NMR data of the catalysts

| Catalyst | | | ³¹P NMR data |
|---|---|---|---|
| No. | Catalyst structure | ¹H NMR data (δ in CDCl₃) | (δ in CDCl₃) |
| I | 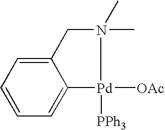 | 7.75 and 7.35 (2m, 15, PPh₃); 6.93 (d), 6.8 (t), 6.34 (m) (4, aromatic-H); 4.02 (d, 2.05 Hz, 2, CH₂N); 2.79 (d, 2.34 Hz, 6, NMe₂); 1.27 (s, 3, OAc) | 43 |
| II | 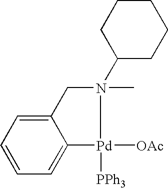 | 7.75 and 7.35 (2m, 15, PPh₃); 6.95 (d), 6.76 (t), 6.32 (m) (4, aromatic-H); 4.27 and 3.98 (dd, 13.2 Hz, 2, CH₂N); 2.88 (d, 2.64 Hz, 3, NMe); 2.55, 1.95-1.2 (m, 11, cyclohexyl); 1.2 (s, 3, OAc) | 42 |
| III | 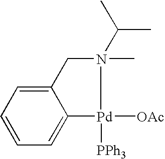 | 7.74 and 7.36 (2m, 15, PPh₃); 6.96 (d), 6.78 (t), 6.33 (m) (4, aromatic-H); 4.21 and 3.88 (dd, 14.0 Hz, 2, CH₂N); 3.34 (m, 1, CHMe₂); 2.83 (d, 2.35 Hz, 3, NMe); 1.37 (dd, 6, CHMe₂); 1.25 (s, 3, OAc) | 42 |
| IV | 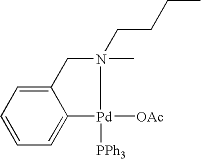 | 7.76 and 7.35 (2m, 15, PPh₃); 6.94 (d), 6.78 (t), 6.33 (m) (4, aromatic-H); 4.10 (dd, 13.2 Hz, 2, CH₂N); 2.80 (d, 2.64 Hz, 3, NMe); 2.8, 1.9, 1.3 and 0.9 (4m, 9, n- butyl); 1.25 (s, 3, OAc) | 42 |
| V | 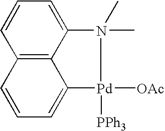 | 7.85, 7.6 and 7.35 (3m, 15 PPh₃, and 4 aromatic-H); 6.68 (t) and 6.48 (t) (2, aromatic-H); 3.34 (d, 2.35 Hz, 6, NMe₂); 1.27 (s, 3, OAc) | 44 |
| VI | 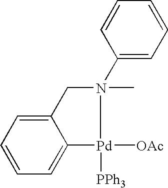 | 7.85-7.2 (m), 7.1 (t), 7.05 (d), 6.8 (m), 6.25 (m) (24 aromatic-H); 4.75 (s, 2, CH₂N); 3.26 (s, 3, NMe); 1.25 (OAc) | 45 |
| VII | 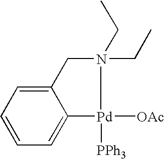 | 7.75 and 7.35 (2m, 15, PPh₃); 6.96 (d), 6.8 (t), 6.32 (m) (4, aromatic-H); 4.12 (d, 1.46 Hz, 2, CH₂N); 3.13 and 2.92 (2m, 4, NCH₂CH₃); 1.45 (t, 6, NCH₂CH₃); 1.21 (s, 3, OAc) | 42 |
| VIII | 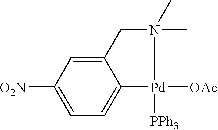 | 7.8-7.15 and 6.5 (m, 18, aromatic-H); 4.1 (br s, 2, CH₂N); 2.8 (s, 6, NMe₂), 1.25 (OAc) | 42 |
| IX | 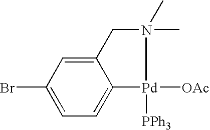 | 7.74 and 7.4 (2m, 15, PPh₃); 6.60 (d), 6.17 (m), 6.035(m) (3, aromatic-H); 3.99 (d, 1.76 Hz, 2, CH₂N); 3.63 (S, 3, OMe); 2.79 (d, 2.35 Hz, 6, NMe₂); 1.27 (s, 3, OAc) | 43 |
| X | 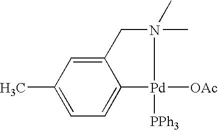 | 7.75 and 7.35 (2m, 15, PPh₃); 6.81 (s), 6.2 (m) (3, aromatic-H); 3.98 (d, 1.76 Hz, 2, CH₂N); 2.78 (d, 2.64 Hz, 6, NMe₂); 2.11 (s, 3, 4-Me); 1.35 (s, 3, OAc) | 43 |
| XI | 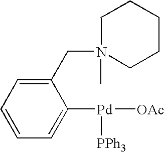 | 7.75 and 7.35 (2m, 15, PPh₃); 7.00 (d), 6.79 (t), 6.32 (m) (4, aromatic-H); 4.33 (d, 1.76 Hz, 2, CH₂N); 3.60 (t), 3.13 (d), 1.9-1.4 (m) (10, azacyclohexane); 1.3 (br s, 3, OAc) | 42 |
| XII | 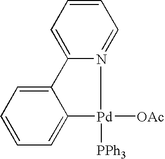 | 8.58 (m), 7.88 (m), 7.42 (m), 7.20 (m), 6.93 (m), 6.54 (m) (15 PPh₃and 8 aromatic-H); 1.37 (s, 3, OAc | 44 |
| XIII | 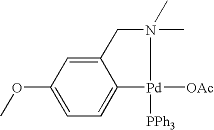 | 7.75 and 7.2 (2m, 15, PPh₃); 7.11 (d), 6.50 (dd), 6.16 (dd), 6.03 (m) (3, aromatic-H); 3.98 (d, 2.06 Hz, 2, CH₂N); 3.62 (s, 3, OMe); 2.78 (d, 2.64 Hz, 6, NMe₂); 1.28 (s, 3, OAc) | 44 |
| XIV | 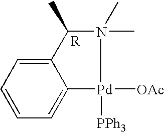 | 7.75 and 7.35 (2m, 15, PPh₃); 6.92 (d), 6.82 (t), 6.34 (m) (4, aromatic-H); 3.74 (m, 1, CHMeN); 2.89 (d, 1.76 Hz, 3, NMe); 2.62 (d, 2.93 Hz, 3, NMe); 1.79 (d, 6.45 Hz, 3, CHMeN); 1.27 (s, 3, OAc) | 43 |
| XV | 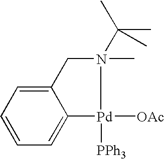 | 7.75 and 7.4 (2m, 15, PPh₃); 6.86 (d), 6.75 (m), 6.27 (m) (4, aromatic-H); 4.18 (s, 2, CH₂N); 2.88 (d, 2.34 Hz, 3, NMe); 1.33 (s, 9, CMe₃); 1.28 (s, 3, OAc) | 43 |
| XVI | 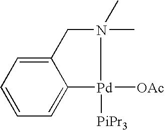 | 7.10 (d) and 6.95 (m) (4, aromatic-H); 3.90 (s, 2, CH₂N); 2.59 (s, 6, NMe₂); 2.5 (m, 3, CHMe₂); 1.9 (s, 3, OAc); 1.3 (dd, 18, CHMe₂) | 52 |
| XVII | 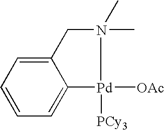 | 7.10 (d) and 6.9 (m) (4, aromatic- H); 3.9 (s, 2, CH₂N); 2.57 (s, 6, NMe₂); 2.1, 1.9-1 (m, 33, cyclohexyl-H); 1.9 (s, 3, OAc) | 41 |
| XVIII | 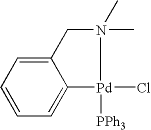 | 7.75 and 7.35 (2m, 15, PPh₃); 6.97 (d), 6.8 (t), 6.35 (m) (4, aromatic-H); 4.03 (5, 2, CH₂N); 2.79 (d, 6, NMe₂); 1.26 (s, 3, OAc) | 43 |
| XIX | 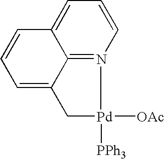 | 8.87 (m), 8.25 (d), 7.8 (m) and 7.4 (m) (21, aromatic-H); 2.83 (d, 2, CH₂); 1.66 (s, 3, Oac) | 35 |

All compounds show satisfactory elemental C, H, N-elemental analysis results
Ac = acetyl,
Ph = phenyl,
Me = methyl.

### Examples 2-17

### Reactivity of the Catalysts in the Suzuki-Coupling Reaction

Reaction scheme for Suzuki coupling of 4-bromoacetophenone with phenylboronic acid:

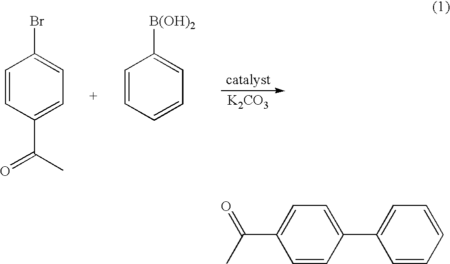

Reaction Conditions:

4-Bromoacetophenone (597 mg, 3 mmol), phenylboronic acid (548 mg, 4.5 mmol), potasium carbonate (829 mg, 6 mmol), and a catalytic amount of the respective palladium catalyst are added to 5.7 ml xylene. The reaction mixture is degassed under vacuum and put under an atmosphere of nitrogen. The reaction mixture is heated to reflux temperature for 1 h after which the reaction is controlled with gas chromatography. The results are given in Table 2.

TABLE 2
Results of Suzuki coupling reaction (1)

| | Catalyst | | | Yield |
|---|---|---|---|---|
| | (if number, | | Amount | after |
| | see | | added | 1 h |
| Example | Example 1) | Mw | (mg) | (GC) |
| 2 | I | 561.9 | 8.4 | 100.0% |
| 3 | XVI | 471.9 | 7.1 | 100.0% |
| 4 | XVII | 580.1 | 8.7 | 100.0% |
| 5 | XVIII | 538.34 | 8.1 | 100.0% |
| 6 | XIV | 576.0 | 8.7 | 100.0% |
| 7 | II | 630.1 | 9.5 | 100.0% |
| 8 | IV | 604.02 | 9.1 | 100.0% |
| 9 | III | 590.0 | 8.9 | 96.5% |
| 10 | IX | 640.49 | 9.6 | 100% |
| 11 | X | 575.7 | 8.7 | 100% |
| 12 | VII | 589.71 | 8.9 | 100% |
| 13 | V | 621.74 | 9.3 | 100% |
| 14 | XI | 601.7 | 9.0 | 100% |
| 15 | XII | 581.71 | 8.7 | 100% |
| 16 | XV | 603.72 | 9.1 | 100% |
| 16b | XIX | 581.71 | 8.7 | 100% |
| 17 | blank | — | — | 0% |

### Examples 18-34

### Suzuki coupling of 3-bromanisole with phenyl boronic acid

Reaction Scheme for Examples 18-34

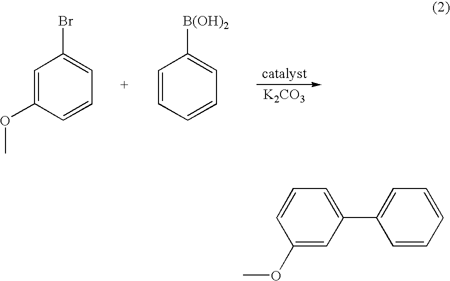

Reaction Conditions:

3-Bromanisole (561 mg, 3 mmol), phenylboronic acid (548 mg, 4.5 mmol), potassium carbonate (829 mg, 6 mmol), and a catalytic amount of the palladium catalyst are added to 5.7 ml xylene. The reaction mixture is degassed under vacuum and put under an atmosphere of nitrogen. The reaction mixture is heated to reflux temperature for 1 h after which the reaction is controlled with gas chromatography. The results are given in Table 3.

TABLE 3
Results of Suzuki coupling reaction (2)

| | Catalyst | | | yield |
|---|---|---|---|---|
| | (if number, | | amount | after |
| | see | | added | 1 hour |
| Example | Example 1) | MW | (mg) | (GC) |
| 18 | I | 561.9 | 8.4 | 90% |
| 19 | XVI | 471.9 | 7.1 | 96% |
| 20 | XVII | 580.1 | 8.7 | 97% |
| 21 | XVIII | 538.34 | 8.1 | 100% |
| 22 | XIV | 576.0 | 8.7 | 79% |
| 23 | II | 630.1 | 9.5 | 100% |
| 24 | IV | 604.02 | 9.1 | 100% |
| 25 | III | 590.0 | 8.9 | 100% |
| 26 | IX | 640.49 | 9.6 | 94% |
| 27 | X | 575.7 | 8.7 | 100% |
| 28 | VII | 589.71 | 8.9 | 77% |
| 29 | V | 621.74 | 9.3 | 91% |
| 30 | XI | 601.7 | 9.0 | 88% |
| 31 | XII | 581.71 | 8.7 | 100% |
| 32 | XV | 603.72 | 9.1 | 100% |
| 33 | VIII | 606.7 | 9.1 | 100% |
| 34 | blank | — | — | 0% |

### Examples 35-47

### Reactivity of the Catalysts in the Heck-Coupling Reaction

Reaction Scheme for Heck coupling of 4-bromoacetophenone with butyl acrylate:

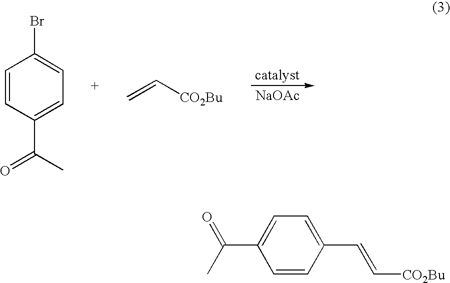

Reaction Conditions:

4-Bromoacetophenone (555 mg, 3 mmol) is dissolved in dimethylacetamide (5.7 ml). This solution is degassed under vacuum and put under an inert atmosphere of nitrogen. To this solution, subsequently a catalytic amount of the catalyst (see Table 3), sodium acetate (492 mg, 6 mmol), and butyl acrylate (577 mg, 4.5 mmol) are added. This reaction mixture is heated to reflux for 1 h, after which the reaction is controlled with gas chromatography.

Results are given in Table 4.

TABLE 4
Results of Heck coupling reaction (3)

| | catalyst | | | yield |
|---|---|---|---|---|
| | (if number, | | amount | after |
| | see | | added | 1 hour |
| example | Example 1) | MW | (mg) | (GC) |
| 35 | IX | 640.5 | 9.6 | 100% |
| 36 | X | 575.7 | 8.7 | 100% |
| 37 | VII | 589.7 | 8.9 | 100% |
| 38 | V | 621.7 | 9.3 | 100% |
| 39 | XI | 601.7 | 9.0 | 100% |
| 40 | XII | 581.7 | 8.7 | 100% |
| 41 | III | 603.7 | 9.1 | 100% |
| 42 | I | 561.9 | 0.009* | 100% |
| 43 | XVII | 580.1 | 0.009* | 100% |
| 44 | XVIII | 538.3 | 0.008* | 100% |
| 45 | X | 575.7 | 0.009* | 100% |
| 46 | XII | 581.7 | 0.009* | 100% |
| 47 | blank | — | — | 0% |

*from a stock solution of the catalyst.

### Example 48

### Reactivity of the Catalysts in Carbonylation Reaction

4-Bromoacetophenone (1.991 g, 1.0 mmol), ethanol (20 ml), triethylamine (1.518 g, 1.5 mmol) and [PdCl(C₆H₄CH₂NMe₂—C,N)(P{C₆H5}₃)] (56 mg, 0.01 mmol) are placed in a stainless steel autoclave. The reactor is closed and the stirred reaction mixture is flushed with argon and then with carbon monoxide. After adjusting the internal carbon monoxide pressure to 20 bar, the autoclave is heated to 115° C. (oilbath), and the stirred reaction mixture kept at this temperature for 16 h. The reactor is then cooled to room temperature and the resulting pale yellow reaction mixture is filtered through a short pad of Hyflo Super Cel® (Kieselgur; trademark of Manville Filtration and Mineral) in order to remove catalyst residues. Purification by column chromatography affords the desired product, 4-acetyl-benzoic acid ethyl ester (1.57 g, 82%), as white solid. Analysis is consistent with those of the data reported by Kubota et al Syn. Left., 1998, pp 183-185.

### Examples 49-53

### Reactivity of the Catalysts in the Suzuki-coupling reaction with hetero aromates

Suzuki coupling of 2-bromopyridine with phenylboronic acid

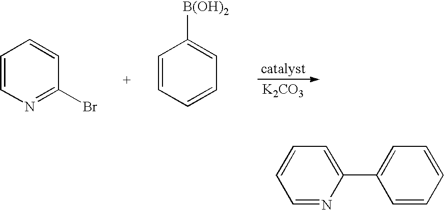

2-bromopyridine (158 mg, 1 mmol), phenylboronic acid (183 mg, 1.5 mmol), pottasium carbonate (277 mg, 2 mmol), and a catalytic amount of the palladium catalyst were added to 2 ml xylol. The reaction mixture was degassed under vacuum and put under an atmosphere of nitrogen. The reaction mixture was heated to reflux temperature for 1 hour afterwhich the reaction was controlled with gas chromatography. The results are given in Table 5.

TABLE 5
Results of Suzuki coupling reaction

| | | | | yield |
|---|---|---|---|---|
| | | | amount | after |
| | | | added | 1 hour |
| example | catalyst | Mw | (mg) | (GC) |
| 49 | 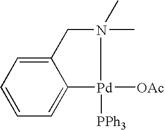 | 531.9 | 3 | 100% |
| 50 | 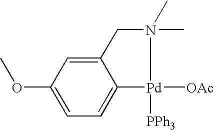 | 561.9 | 3 | 100% |
| 51 | 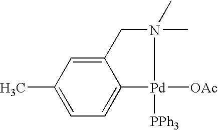 | 575.7 | 3 | 100% |
| 52 | 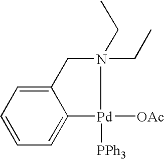 | 589.71 | 3 | 100% |
| 53 | 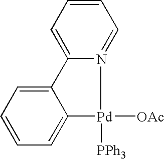 | 581.71 | 3 | 100% |

### Examples 54-58

### Reactivity of the catalysts in the Suzuki-coupling reaction with hetero aromates

Suzuki coupling of 3-bromopyridine with phenylboronic acid

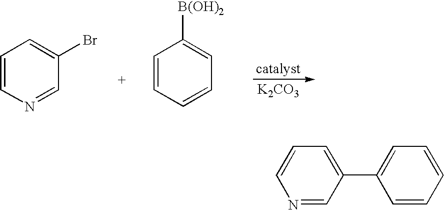

3-bromopyridine (158 mg, 1 mmol), phenylboronic acid (183 mg, 1.5 mmol), pottasium carbonate (277 mg, 2 mmol), and a catalytic amount of the palladium catalyst were added to 2 ml xylol. The reaction mixture was degassed under vacuum and put under an atmosphere of nitrogen. The reaction mixture was heated to reflux temperature for 1 hour afterwhich the reaction was controlled with gas chromatography. The results are given in Table 6.

TABLE 6
Results of Suzuki coupling reaction

| | | | | yield |
|---|---|---|---|---|
| | | | amount | after |
| | | | added | 1 hour |
| example | catalyst | Mw | (mg) | (GC) |
| 54 | 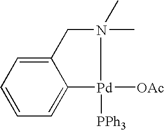 | 531.9 | 3 | 100% |
| 55 | 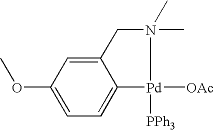 | 561.9 | 3 | 100% |
| 56 | 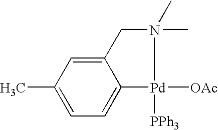 | 575.7 | 3 | 100% |
| 57 | 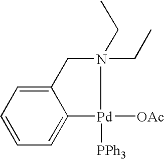 | 589.71 | 3 | 100% |
| 58 | 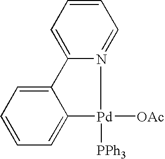 | 581.71 | 3 | 100% |

### Examples 59-63

### Reactivity of the catalysts in the Suzuki-coupling reaction with hetero aromates

Suzuki coupling of 2-bromothiophene with phenylboronic acid

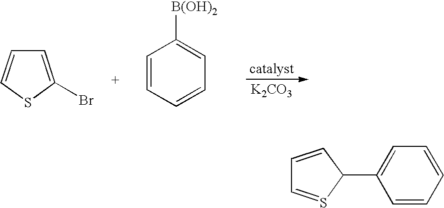

2-bromothiophene (163 mg, 1 mmol), phenylboronic acid (183 mg, 1.5 mmol), pottasium carbonate (277 mg, 2 mmol), and a catalytic amount of the palladium catalyst were added to 2 ml xylol. The reaction mixture was degassed under vacuum and put under an atmosphere of nitrogen. The reaction mixture was heated to reflux temperature for 2 hours afterwhich the reaction was controlled with gas chromatography. The results are given in Table 7.

TABLE 7
Results of Suzuki coupling reaction

| | | | | yield |
|---|---|---|---|---|
| | | | amount | after |
| | | | added | 2 hours |
| example | catalyst | Mw | (mg) | (GC) |
| 59 | 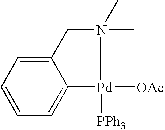 | 531.9 | 3 | 100% |
| 60 | 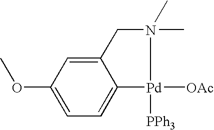 | 561.9 | 3 | 100% |
| 61 | 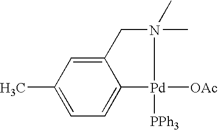 | 575.7 | 3 | 100% |
| 62 | 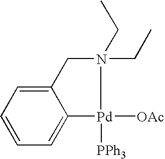 | 589.71 | 3 | 100% |
| 63 | 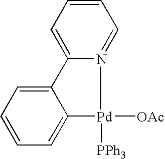 | 581.71 | 3 | 100% |

1. A catalyst compound of the formula I, 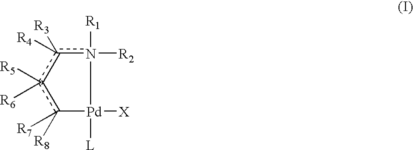
wherein
either
(i) R₁ and R₂ together with R₃ and R₄ and R₅ and R₆, and together with the atoms to which they are bound, form an unsubstituted or substituted quinolylene ring system, while R₇ and R₈, independently of each other, are hydrogen or an organic group; or
(ii) R₃ and R₄ together with R₅ and R₆ and R₇ and 1%, and together with the atoms to which they are bound, form an unsubstituted or substituted naphthylene ring system, while R₁ and R₂, independently of each other, are H or an organic group; or
(iii) R₃ and R₄ together with R₅ and R₆, and together with the atoms to which they are bound, form an unsubstituted or substituted phenylene ring, while R₁, R₂, R₇ and R₈, independently of each other, are H or an organic group; or
(iv) R₅ and R₆, together with R₇ and R₈, and together with the atoms to which they are bound, form an unsubstituted or substituted phenylene ring, while R₁, R₂, R₃ and R₄, independently of each other, are H or an organic group; or
(v) R₁ and R₂, together with R₃ and R₄, and together with the atoms to which they are bound form an unsubstituted or substituted pyridylene ring, while R₅ and R₆, together with R₇ and R₈, and together with the atoms to which they are bound, form an unsubstituted or substituted phenylene ring;
with the proviso that where R₁ and R₂ do not form part of an unsubstituted or substituted quinolylene or pyridylene ring system they may, instead of each being hydrogen or an organic group, together form an unsubstituted or substituted alkylene that together with the binding nitrogen forms a ring;
where the bonds represented by dotted lines in formula I together with the adjacent bonds in solid line in the case that they are part of a phenyl or pyridyl ring are delocated double bonds forming part of the phenyl or pyridyl ring, in case that they are not part of such a ring are absent;
X is an anionic ligand;
and L is a tertiary phosphine moiety.

2. A catalyst compound of the formula I according to claim 1 wherein either
(i) R₁ and R₂ together with R₃ and R₄ and R₅ and R₆, and together with the atoms to which they are bound, form an unsubstituted or substituted quinolylene ring system, while R₇ and R₈, independently of each other, are hydrogen or an organic group; or
(ii) R₃ and R₄ together with R₅ and R₆ and R₇ and R₈, and together with the atoms to which they are bound, form an unsubstituted or substituted naphthylene ring system, while R₁ and R₂, independently of each other, are H or an organic group; or
(iii) R₃ and R₄ together with R₅ and R₆, and together with the atoms to which they are bound, form an unsubstituted or substituted phenylene ring, while R₁, R₂, R₇ and R₈, independently of each other, are H or an organic group; or
(iv) R₅ and R₆, together with R₇ and R₈, and together with the atoms to which they are bound, form an unsubstituted or substituted phenylene ring, while R₁, R₂, R₃ and R₄, independently of each other, are H or an organic group; or
(v) R₁ and R₂, together with R₃ and R₄, and together with the atoms to which they are bound form an unsubstituted or substituted pyridylene ring, while R₅ and R₆, together with R₇ and R₈, and together with the atoms to which they are bound, form an unsubstituted or substituted phenylene ring;
with the proviso that where R₁ and R₂ do not form part of an unsubstituted or substituted quinolylene or pyridylene ring system, R₃ and R₄ are, independently of each other, hydrogen or an organic group and R₅ and R₆, together with R₇ and R₈, and together with the atoms to which they are bound, form an unsubstituted or substituted phenylene ring, R₁ and R₂ may, instead of each being hydrogen or an organic group, together form an unsubstituted or substituted alkylene that together with the binding nitrogen forms a ring;
where the bonds represented by dotted lines in formula I together with the adjacent bonds in solid line in the case that they are part of a phenyl or pyridyl ring are delocated double bonds forming part of the phenyl or pyridyl ring, in case that they are not part of such a ring are absent;
X is an anionic ligand selected from the group consisting of halogen anions, especially Cl⁻, Br⁻ or I⁻, and most preferably the anion of a lower alkylcarbonic acid, especially acetate;
and L is a tertiary phosphine moiety.

3. A catalyst compound of the formula I according to claim 1 wherein
(i) R₁ and R₂ together with R₃ and R₄ and R₅ and R₆, and together with the atoms to which they are bound, form an unsubstituted quinolylene ring system, while R₇ and R₈, independently of each other, are hydrogen or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or
(ii) R₃ and R₄ together with R₅ and R₆ and R₇ and R₈, and together with the atoms to which they are bound, form an unsubstituted naphthylene ring system, while R₁ and R₂, independently of each other, are H or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or
(iii) R₃ and R₄ together with R₅ and R₆, and together with the atoms to which they are bound, form an unsubstituted phenylene ring, while R₁, R₂, R₇ and R₈, independently of each other, are H or an organic group selected from unsubstituted alkyl, especially lower alkyl, unsubstituted cycloalkyl, especially C₃-C₁₀-cycloalkyl, most preferably cyclohexyl or cyclopentyl, and unsubstituted aryl, especially phenyl; or
(iv) R₅ and R₆, together with R₇ and R₈, and together with the atoms to which they are bound, form an unsubstituted phenylene ring, while R₁, R₂, R₃ and R₄, independently of each other, are H or an organic group selected from unsubstituted alkyl, especially lower alkyl, unsubstituted cycloalkyl, especially C₃-C₈-cycloalkyl, most preferably cyclohexyl or cyclopentyl, and unsubstituted aryl, especially phenyl; or
(v) R₁ and R₂, together with R₃ and R₄, and together with the atoms to which they are bound form an unsubstituted pyridylene ring, while R₅ and R₆, together with R₇ and R₈, and together with the atoms to which they are bound, form an unsubstituted phenylene ring;
with the proviso that where R₁ and R₂ do not form part of an unsubstituted quinolylene or pyridylene ring system, R₃ and R₄ are, independently of each other, hydrogen or an organic group as defined and R₅ and R₆, together with R₇ and R₈, and together with the atoms to which they are bound, form an unsubstituted phenylene ring, R₁ and R₂ may, instead of each being hydrogen or an organic group as defined, together form an unsubstituted or substituted C₃-C₆-alkylene that together with the binding nitrogen forms a ring;
X is an anionic ligand selected from the group consisting of halogen anions, especially Cl⁻, Br⁻ or I⁻, and most preferably the anion of a lower alkylcarbonic acid, especially acetate;
and L is a tertiary phosphine moiety of the formula 1 A
R₉R₁₀R₁₁ (1A),
wherein R₉, R₁₀ and R₁₁ are, independently of each other, lower alkyl, especially methyl, ethyl, n- or isopropyl or n-, sec- or tert-butyl as well as linear or branched pentyl, hexyl or heptyl; or further octyl, isooctyl, nonyl, tert-nonyl, decyl, undecyl or dodecyl; C₃-C₈-cycloalkyl, especially cyclopropyl, dimethylcyclopropyl, cyclobutyl, cyclopentyl or cyclohexyl; or C₆-C₁₄-aryl, especially phenyl, naphthyl, indenyl, azulenyl or anthryl.

4. A catalyst compound of the formula I according any one of claims 1 to 3 wherein R₁, R₂, R₃, R₄, R₅, R₆, R₇ and R₈ are as defined in any one of the groups (i), (ii), (iii), (iv) and (v) and the remaining symbols have the meanings given in said claims.

5. A catalyst compound of the formula I according to any one of claims 1 to 4 wherein
(i) R₁ and R₂ together with R₃ and R₄ and R₅ and R₆, and together with the atoms to which they are bound, form an unsubstituted quinolylene ring system, while R₇ and R₈, independently of each other, are hydrogen, lower alkyl, C₃-C₈-cycloalkyl, especially cyclopentyl or cyclohexyl, or C₆-C₁₀-aryl, especially phenyl; or
(ii) R₃ and R₄ together with R₅ and R₆ and R₇ and R₈, and together with the atoms to which they are bound, form an unsubstituted naphthylene ring system, while R₁ and R₂, independently of each other, are H or are hydrogen, lower alkyl, C₃-C₈-cycloalkyl, especially cyclopentyl or cyclohexyl, or C₆-C₁₀-aryl, especially phenyl; or
(iii) R₃ and R₄ together with R₅ and R₆, and together with the atoms to which they are bound, form an unsubstituted phenylene ring, while R₁, R₂, R₇ and R₈, independently of each other, are H, are hydrogen, lower alkyl, C₃-C₈-cycloalkyl, especially cyclopentyl or cyclohexyl, or C₆C₁₀-aryl, especially phenyl; or
(iv) R₅ and R₆, together with R₇ and R₈, and together with the atoms to which they are bound, form an unsubstituted phenylene ring, while R₁, R₂, R₃ and R₄, independently of each other, are hydrogen, lower alkyl, C₃-C₈-cycloalkyl, especially cyclopentyl or cyclohexyl, or C₆-C₁₀-aryl, especially phenyl; or
(v) R₁ and R₂, together with R₃ and R₄, and together with the atoms to which they are bound form an unsubstituted pyridylene ring, while R₅ and R₆, together with R₇ and R₈, and together with the atoms to which they are bound, form an unsubstituted phenylene ring;
with the proviso that where R₁ and R₂ do not form part of an unsubstituted quinolylene or pyridylene ring system, R₃ and R₄ are, independently of each other, hydrogen or an organic group selected from the group consisting of lower alkyl, C₃-C₈-cycloalkyl, especially cyclopentyl or cyclohexyl, and C₆-C₁₀-aryl, especially phenyl, and R₅ and R₆, together with R₇ and R₈, and together with the atoms to which they are bound, form an unsubstituted phenylene ring, R₁ and R₂ may, instead of each being hydrogen or an organic group as defined, together form an unsubstituted or substituted C₃-C₆-alkylene, especially pentamethylene, that together with the binding nitrogen forms a ring;
X is an anionic ligand selected from the group consisting of halogen anions, especially Cl⁻, Br⁻ or I⁻, and most preferably the anion of a lower alkylcarbonic acid, especially acetate;
and L is a tertiary phosphine moiety selected from triphenylphospinyl, tricyclohexylphosphinyl and tri-lower alkylphosphinyl, especially tri-isopropylphosphinyl.

6. A catalyst compound of the formula I according to any one of claims 1 to 5 wherein X is acetate and the remaining symbols have the meanings given in the corresponding claim, respectively.

7. A catalyst compound selected from the group of compounds having the following formulae:

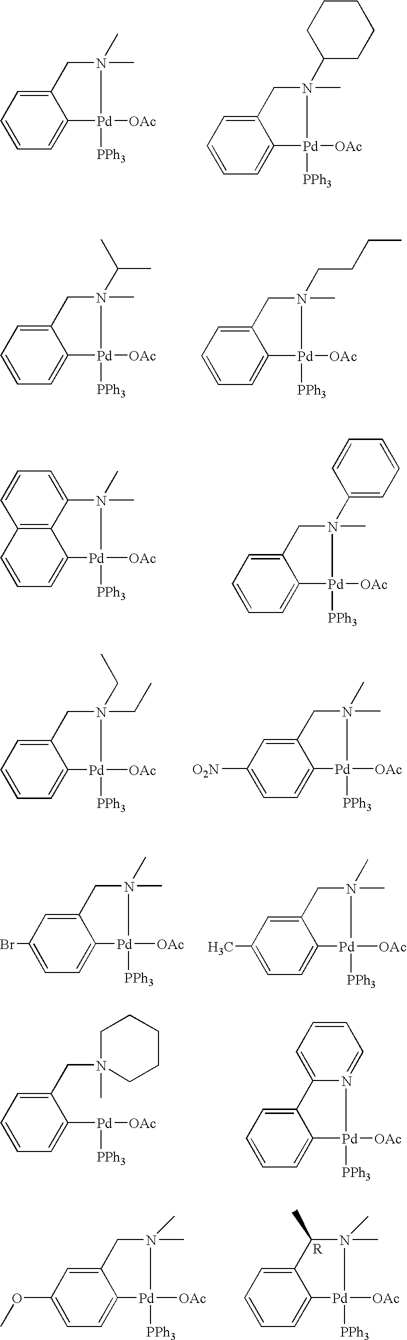

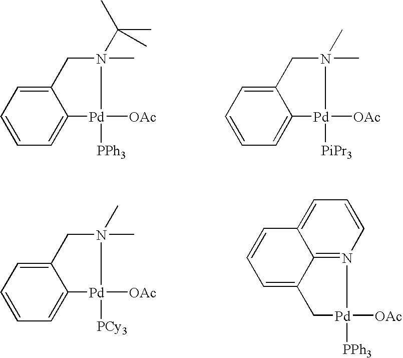

8. A process for the manufacture of a catalyst compound of the formula I as defined in any one of claims 1 to 7, comprising
reacting a compound of the formula II, 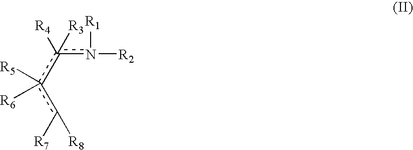
wherein R₁, R₂, R₃, R₄, R₅, R₆, R₇ and R₈ have the meanings given under formula I, with a palladium salt of the formula III,
Pd(X)₂ (III)
wherein X is an anionic ligand as described for compounds of the formula I, in an appropriate solvent; isolating the product complex; and then, optionally directly in situ in the reagent mixture that is to be used for C—C— or C—N— coupling catalysis, reacting the product complex with the tertiary phosphine of the formula IV,
L (IV)
where L is a tertiary phosphine as defined for L for compounds of formula I, in an appropriate solvent; and then either directly using the resulting complex of formula I or isolating it.

9. The use of a compound of the formula I according to any one of claims 1 to 6 as catalyst in catalytic C,C- and C,N-coupling reactions.
